(19) United States
(12) Patent Application Publication
(10) Pub. No.: US 2026/0095959 A1
(43) Pub. Date: Apr. 2, 2026

(54) Location Determination for a Wirelessly Locatable Tag

(71) Applicant: Apple Inc., Cupertino, CA (US)

(72) Inventors: Vignesh Babu MOORTHY, San Jose, CA (US); Benjamin A WERNER, San Jose, CA (US); Brian G KILBERG, San Francisco, CA (US)

(21) Appl. No.: 18/899,821

(22) Filed: Sep. 27, 2024

(51) Int. Cl. H04W 76/10; H04W 8/22

(52) U.S. Cl. CPC H04W 76/10; H04W 8/22

(57) ABSTRACT

An apparatus configured to determine the apparatus is in a predetermined environment, determine there is no active communication connection to a wireless communication device and alter a parameter associated with establishing an active communication connection. Also, an apparatus configured to determine context information for the apparatus, in response to the context information, determine there is no active communication connection to a wirelessly locatable tag and alter a parameter associated with establishing an active communication connection.

### BACKGROUND

Wirelessly locatable tags attached to an object allow a user associated with the wirelessly locatable tag to determine the location of the object. However, there may be issues associated with receiving accurate location information from the wirelessly locatable tag. These issues may include, for example, artifacts and metal composition of an environment creating material attenuation, noise from other devices and/or communication protocols, etc. Thus, there is a need to improve the location determination for wirelessly locatable tags.

### SUMMARY

Some example embodiments are related to an apparatus having processing circuitry configured to determine the apparatus is in a predetermined environment, determine there is no active communication connection to a wireless communication device and alter a parameter associated with establishing an active communication connection.

Other example embodiments are related to an apparatus having processing circuitry configured to determine context information for the apparatus, in response to the context information, determine there is no active communication connection to a wirelessly locatable tag and alter a parameter associated with establishing an active communication connection.

### BRIEF DESCRIPTION OF THE DRAWINGS

FIG. 1 shows an example arrangement of a wireless communication device and a wirelessly locatable tag according to various example embodiments.

FIG. 2 shows an example wireless communication device according to various example embodiments.

FIG. 3 shows an example wirelessly locatable tag according to various example embodiments.

FIG. 4 shows an example method of a use case for locating a wirelessly locatable tag according to various example embodiments.

### DETAILED DESCRIPTION

The example embodiments may be further understood with reference to the following description and the related appended drawings, wherein like elements are provided with the same reference numerals. The example embodiments relate to determining a wirelessly locatable tag is in a predetermined environment such as a luggage carousel and operations performed by the wirelessly locatable tag and/or a wireless communication device communicating with the wirelessly locatable tag to aid a user in locating the wirelessly locatable tag in the predetermined environment.

The example embodiments are described with regard to a wireless communication device. However, reference to a wireless communication device is merely provided for illustrative purposes. The example embodiments may be utilized with any electronic component that may be used with a wirelessly locatable tag to track the location of the wirelessly locatable tag and is configured with the hardware, software, and/or firmware to track the wirelessly locatable tag. Therefore, the wireless communication device as described herein is used to represent any electronic component.

The example embodiments are described with regard to a wirelessly locatable tag. However, reference to a wirelessly locatable tag is merely provided for illustrative purposes. The example embodiments may be utilized with any electronic component that may be used to communicate with a wireless communication device to determine a location of the electronic component.

The example embodiments are also described with reference to a specific use case where the wirelessly locatable tag is placed in a piece of luggage and the task is to locate the luggage at a carousel in an airport. This is only an example use case and the example embodiments may be used in other use cases, e.g., the wirelessly locatable tag may be placed in or attached to a different type of object, the general location may not be an airport, etc. The example use case describes various issues (e.g., material attenuation, interference from other wireless protocols, etc.) that may occur in the airport scenario. However, these issues may also occur in other scenarios and the example embodiments may be used in these other scenarios to address the issues, e.g., the example embodiments may be implemented in any predetermined environment that exhibits issues such as the issues described herein.

Some example embodiments provide operations for a wirelessly locatable tag to determine the wirelessly locatable tag is in a predetermined environment. Other example embodiments provide operations performed by the wirelessly locatable tag when it is in the predetermined environment. These operations include changing parameters to attempt to connect to a wireless communication device, indicating to the wireless communication device that the wirelessly locatable tag is in the predetermined environment and providing parameters related to the predetermined environment to the wireless communication device. Still further example embodiments are related to operations performed by the wireless communication device based on the wirelessly locatable tag being in the predetermined environment. These and other example embodiments are described in greater detail below.

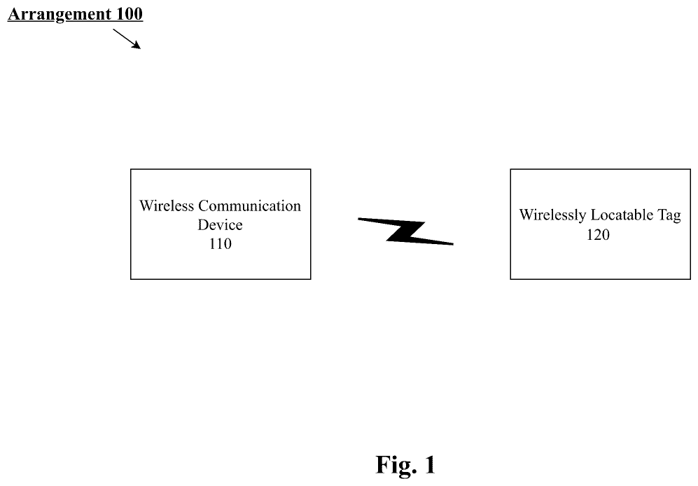

FIG. 1 shows an example arrangement 100 of a wireless communication device 110 and a wirelessly locatable tag 120 according to various example embodiments. The example arrangement 100 includes a wireless communication device 110. The wireless communication device 110 may represent any type of electronic component that is capable of communicating with one or more wirelessly locatable tags. Specific examples of the wireless communication device 110 include, but are not limited to, mobile phones, tablet computers, desktop computers, smartphones, embedded devices, wearables, Internet of Things (IoT) devices, video game consoles, media players, entertainment devices, smart speakers, smart TVs, streaming devices, etc.

The wirelessly locatable tag 120 may be any device that is able to communicate with the wireless communication device 110 to provide the wireless communication device 110 with location information for the wirelessly locatable tag 120. In some example embodiments, the wirelessly locatable tag 120 may transmit a signal (e.g., an advertisement) via a short range communication protocol, e.g., Bluetooth, Bluetooth Low Energy (BLE), ultra-wideband (UWB), etc. The wireless communication device 110 may receive the signal and may perform a connection procedure with the wirelessly locatable tag 120. After connecting, the wirelessly locatable tag 120 and the wireless communication device 110 may perform a ranging operation to determine the location of the wirelessly locatable tag 120. This location may then be displayed to a user of the wireless communication device 110, e.g., via a graphic user interface (GUI), so that the user may retrieve the object associated with the wirelessly locatable tag 120, e.g., a piece of luggage in which the wirelessly locatable tag 120 was placed.

This is the ideal scenario where the wirelessly locatable tag 120 and the wireless communication device 110 are able to communicate and perform the location determination without any issues. However, as will be described in greater detail below, various issues may arise when attempting to determine the location of the wirelessly locatable tag 120. The example embodiments address these issues to improve the location determination.

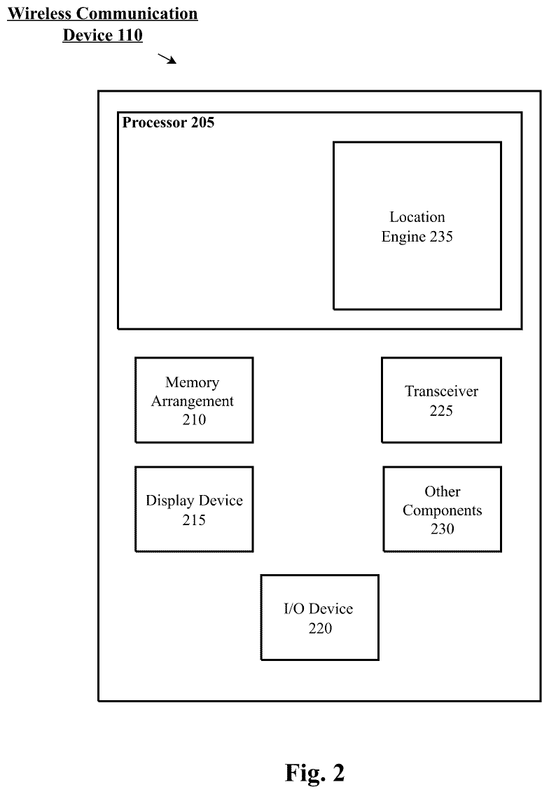

FIG. 2 shows an example wireless communication device 110 according to various example embodiments. The wireless communication device 110 will be described with regard to the arrangement 100 of FIG. 1. The wireless communication device 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the wireless communication device 110 to other electronic devices, etc.

The processor 205 may be configured to execute a plurality of engines of the wireless communication device 110. For example, the engines may include a location engine 235. The location engine 235 may be configured to perform operations related to determining a location of a wirelessly locatable tag. These operations will be described in greater detail below.

The above referenced engine being an application (e.g., a program) executed by the processor 205 is only example. The functionality associated with the engines may also be represented as a separate incorporated component of the wireless communication device 110 or may be a modular component coupled to the wireless communication device 110, e.g., an integrated circuit with or without firmware. For example, the integrated circuit may include input circuitry to receive signals and processing circuitry to process the signals and other information. The engines may also be embodied as one application or separate applications. In addition, in some wireless communication devices, the functionality described for the processor 205 is split among two or more processors such as a baseband processor and an applications processor. The example embodiments may be implemented in any of these or other configurations of a wireless communication device.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the wirelessly locatable tag or any other wireless communication device. Accordingly, the transceiver 225 may operate on a variety of different frequencies or channels (e.g., set of consecutive frequencies). For example, the transceiver may be configured to operate on frequencies associated with the Bluetooth protocol or the UWB protocol to exchange signals with other wireless communication devices operating on these protocols, including, but not limited to the wirelessly locatable tag. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals for implementing any one of the methods described herein.

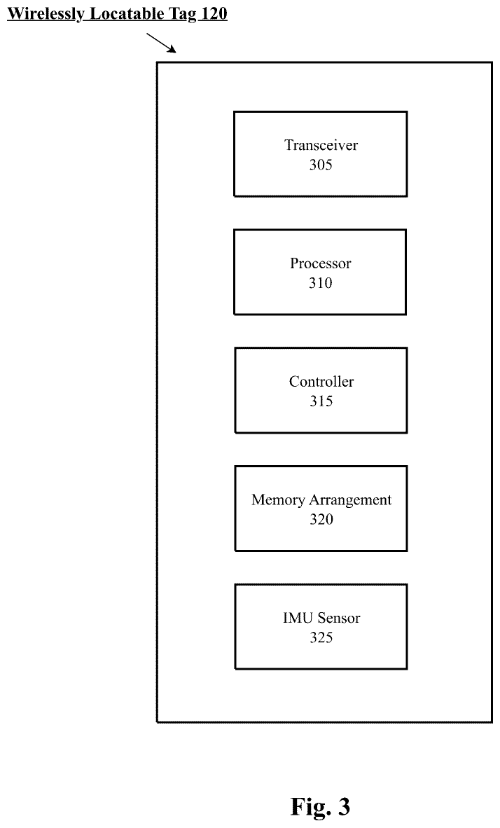

FIG. 3 shows an example wirelessly locatable tag 120 according to various example embodiments. The wirelessly locatable tag 120 may include a transceiver 305, a processor 310, a controller 315, a memory arrangement 320 and an inertial measurement unit (IMU) sensor 325. In addition, the wirelessly locatable tag 120 may include other components (not shown) such as, but not limited to, a battery, ports to electrically connect the wirelessly locatable tag 120 to other electronic devices, etc.

The transceiver 305 may represent one or more hardware components configured to perform operations related to wireless communication. For example, the transceiver 305 may represent one or more radios configured to communicate with a network or another device such as the wireless communication device 110. The transceiver 305 may enable a short-range connection to be established using frequencies or channels associated with the short-range connection (e.g., Bluetooth). The transceiver 305 includes circuitry configured to transmit and/or receive signals (e.g., control signals, data signals). Such signals may be encoded with information implementing any one of the methods described herein. Accordingly, the transceiver 305 may operate on a variety of different frequencies or channels (e.g., set of consecutive frequencies).

The processor 310 may be configured to execute a plurality of engines for the wirelessly locatable tag 120. For example, the processor 310 may perform operations related to a location determination for the wirelessly locatable tag 120. In some embodiments, the processor 310 may be represented as a separate incorporated component of the wirelessly locatable tag 120 or may be a modular component coupled to the wirelessly locatable tag 120, e.g., an integrated circuit with or without firmware. For example, the processor 310 may be a chip or integrated circuit compatible with the short-range communication protocol that includes input circuitry to receive signals and processing circuitry to process the signals and other information. The engines may also be embodied as one application or separate applications.

The controller 315 may be configured to control the communication functions of the transceiver 305 and/or the processor 310. In addition, the controller 315 may also control non-communication functions related to the other components such as the memory arrangement 320, the IMU sensor 325, the battery, etc. Accordingly, the controller 315 may perform operations associated with an applications processor. The example embodiments may be implemented in any of these or other configurations of an audio output device.

The wirelessly locatable tag 120 may also have a memory arrangement 320. The memory arrangement 320 may be a hardware component configured to store data of the wirelessly locatable tag 120. For example, the memory arrangement 320 may store sensor data collected by the IMU sensor 325, may store identification data associated with the associated with the wirelessly locatable tag 120, etc.

The IMU 325 may be used to determine movement of the wirelessly locatable tag 120 including both linear movement and angular movement. In addition, the IMU 325 may also be used to determine an orientation of the wirelessly locatable tag 120. The IMU 325 may include one or both of accelerometers and gyroscopes to determine the movement/orientation of the wirelessly locatable tag 120. The use of the information generated by the IMU 325 is described in greater detail below.

As stated above, in an ideal situation, the wireless communication device 100 and the wirelessly locatable tag 120 will connect and perform the location determination (e.g., ranging) without any issues. However, in actual use cases, various issues may arise. For example, in the airport use case, artifacts and the metal composition of the carousel may create material attenuation. For example, this may result in the wireless communication device 100 and the wirelessly locatable tag 120 being able to connect but transmissions (Tx) and receptions (Rx) may be dropped (e.g., during the ranging operation) causing the devices to not accurately perform the location determination.

In another example, when the wireless communication device 100 and the wirelessly locatable tag 120 are communicating using Bluetooth (BT), the BT channels (e.g., CH 37, 38, 39, etc.) may be too close in proximity (e.g., in frequency) to the Wi-Fi noise floor of available Airport Public Wi-Fi networks (e.g., 2.4 GHz). This may cause cross-interference and amplitude fluctuations leading to improper BT decoding. For example, Wi-Fi interference with BT Channel-39 (e.g., 2480 MHz) may result in devices not being able to decode Rx packets accurately whether through BT or Wi-Fi. Thus, while the ideal scenario allows the wireless communication device 110 to display the location of the wirelessly locatable tag 120 to the user, there are many scenarios where this location cannot be displayed or is inaccurate.

As stated above, the example embodiments are described with reference to the example use case of finding the wirelessly locatable tag 120 that was placed in or attached to a piece of luggage at an airport. However, the example embodiments are not limited to this use case. For example, the attenuation and/or interference scenarios described above may take place in other settings.

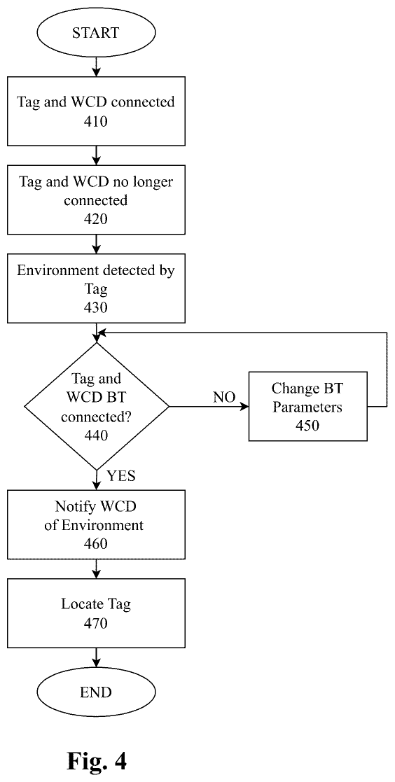

FIG. 4 shows an example method 400 of a use case for locating a wirelessly locatable tag according to various example embodiments. The example method 400 may include operations performed by a wireless communication device (e.g., the wireless communication device 110) and a wirelessly locatable tag (e.g., the wirelessly locatable tag 120). The wirelessly locatable tag 120 may include various capabilities such as communicating via Bluetooth or Ultra-Wideband (UWB) (e.g., using the transceiver 305 described above) and may include an IMU sensor (e.g., the IMU sensor 325 described above. Similarly, the wireless communication device 120 may also include various capabilities such as UWB Ranging Measurements, Light Detection and Ranging (Lidar), a camera, IMU sensor, a Global Navigation Satellite System (GNSS), a barometer (e.g., for elevation measurements), Bluetooth connectivity, WiFi connectivity, etc. The capabilities are only examples and the wireless communication device 110 and the wirelessly locatable tag 120 are not required to have all these capabilities.

In a first operation 410, the wireless communication device 110 and the wirelessly locatable tag 120 may be connected via a Bluetooth connection. In this example, the first operation 410 may occur at a departing airport where a user associated with the wireless communication device 110 and the wirelessly locatable tag 120 has placed the wirelessly locatable tag 120 in a piece of luggage. The manner of associating the wireless communication device 110 and the wirelessly locatable tag 120 is beyond the scope of this disclosure and any method of associating the wireless communication device 110 and the wirelessly locatable tag 120 may be used. For example, the wireless communication device 110 may include an application executable by the processor 205 that allows a user to associate the wireless communication device 110 with the wirelessly locatable tag 120, e.g., a Bluetooth pairing application including the exchange of pairing information.

In a second operation 420, the wireless communication device 110 and the wirelessly locatable tag 120 may no longer be connected via the Bluetooth connection. The second operation 420 may start, for example, when the user dropped their luggage off in the airport and may continue during the time the user is in-flight. In some example embodiments, when the user drops their luggage at the airport and the Bluetooth connection is dropped, the wireless communication device 110 may generate an alert for a user indicating that the luggage has been checked and may display this alert or produce an audio tone indicating the luggage has been checked. During this second time 415, wireless communication device 110 and the wirelessly locatable tag 120 may be in a travel mode, e.g., the wireless communication device 110 and the wirelessly locatable tag 120 may not attempt to connect and/or perform location operations because the devices determine that in the travel mode there is no need to connect. In addition, the wireless communication device 110 may have been placed in airplane mode during the flight.

At a later time, the plane may have landed. At this time, the wirelessly locatable tag 120 may exit the travel mode. When the travel mode is exited, the IMU sensor 325 of the wirelessly locatable tag 120 may periodically (or continuously) perform measurements to determine positioning information for the wirelessly locatable tag 120. In addition, the user of the wireless communication device 110 may have switched the wireless communication device 110 out of airplane mode into a normal mode of operation. The wireless communication device 110 may be capable of determining context information. For example, the wireless communication device 110 may determine that the wireless communication device 110 experienced a flight condition based on the fact that the wireless communication device 110 was in airplane mode for a period of time and the barometer indicated that the wireless communication device 110 was at an elevation consistent with being in an airplane. This is only an example, and other manners may be used to determine context information for the wireless communication device 110. As will be described in greater detail below, this context information may be used in certain scenarios to improve the location determination for the wirelessly locatable tag 120.

In 430, the wirelessly locatable tag 120 may determine an environment. For example, the wirelessly locatable tag 120 may determine that the luggage has arrived at a luggage carousel. In some example embodiments, the IMU 325 of the wirelessly locatable tag 120 may be used to determine if the wirelessly locatable tag 120 is currently on a luggage carousel. The following provides an example algorithm for determining whether the wirelessly locatable tag 120 is on a carousel.

However, this is only an example and other algorithms may be used and/or developed to determine the wirelessly locatable tag 120 is on a carousel. In the example algorithm, the IMU 325 may provide X, Y, Z acceleration data. A high pass filter may be applied to the signal power of the acceleration data (e.g., signals above 4-5 Hz are passed by the filter) and the total power of these passed signals is determined and compared to a threshold. If the total power is above the threshold, this is an indication that the movement (or vibration) the wirelessly locatable tag 120 is experiencing is related to being on a carousel. A low pass filter may also be applied to the signal power signal power of the acceleration data to determine a total power of these low frequency passed signals that is also compared to a threshold. If the total power of the lower frequency signal is below the threshold this is also an indication that the movement (or vibration) the wirelessly locatable tag 120 is experiencing is related to being on a carousel. The amount of angular deflection in the acceleration data may also be used to determine if the wirelessly locatable tag 120 is experiencing tilting or rolling, e.g., when on the carousel the wirelessly locatable tag 120 should not be experiencing tilting or rolling. In the example algorithm, these three factors may be used to determine if the wirelessly locatable tag is on a carousel. Again, this is just one example algorithm and other algorithms may be used to determine the wirelessly locatable tag 120 is on a carousel.

Once the wirelessly locatable tag 120 has determined it is on the carousel, in 440, the wirelessly locatable tag 120 may determine whether it has established a Bluetooth connection with the wireless communication device 110. If the wirelessly locatable tag 120 has not established a Bluetooth connection with the wireless communication device 110, in 450, the wirelessly locatable tag 120 may change parameters associated with the Bluetooth advertisements that the wirelessly locatable tag 120 is transmitting. These parameters may include, for example, increasing the Bluetooth advertisement rate, increasing the transmit power of the Bluetooth advertisements, etc.

In this example, the wirelessly locatable tag 120 may use the information that it is currently on a carousel to determine that a user is attempting to locate the luggage and wants to establish the Bluetooth connection between the wirelessly locatable tag 120 and the wireless communication device 110. Therefore, the wirelessly locatable tag 120 may advertise more aggressively until the connection is established. For example, the wirelessly locatable tag 120 may loop through the operations 440 and 450 until the Bluetooth connection is established, e.g., increasing the advertisement rate and/or transmit power in increments until a maximum rate and/or transmit power is reached. In some example embodiments, if the Bluetooth connection is not established within a predetermined period of time, e.g., based on a timer that is started when carousel detection is determined, the wirelessly locatable tag 120 may stop advertising or reduce the advertising rate/power to reduce power consumption. For example, if a false positive of carousel detection is determined, the wirelessly locatable tag 120 may not want to continue to advertise aggressively because of the power drain.

This process may allow the specific advertisements to be fine-tuned to certain active acceleration ranges from 1-2 seconds or 1-2 Mbps based on the particular channel selection and the Wi-Fi noise floor. This may allow for accurate wirelessly locatable tag 120 advertisement Bluetooth modulation.

Similar to the wirelessly locatable tag 120, when the wireless communication device 110 determines that it has arrived at its destination, e.g., based on the context information described above, the wireless communication device 110 may use the information to determine that the user is attempting to locate the luggage and wants to establish the Bluetooth connection between the wirelessly locatable tag 120 and the wireless communication device 110. In some example embodiments, a user of the wireless communication device 110 may input information into an application related to the wirelessly locatable tag 120 installed on the wireless communication device 110 (e.g., via a graphical user interface (GUI)) that the user is attempting to locate for the wirelessly locatable tag 120. Thus, in 440, the wireless communication device 110 may also determine whether the Bluetooth connection has been established.

If the Bluetooth connection has not been established, the wireless communication device 110 may also change its Bluetooth parameters in 450 to more aggressively scan for the wirelessly locatable tag 120. For example, the wireless communication device 110 may increase a Bluetooth scan rate, may increase a transmit power or may perform Bluetooth channel hopping to attempt to connect to the wirelessly locatable tag 120. Similar to the description above for the wirelessly locatable tag 120, the wireless communication device 110 may loop through the operations 440 and 450 until a Bluetooth connection is established.

For example, the wirelessly locatable tag 120 may inform the wireless communication device 110 of certain metrics such as carousel speed, acceleration and carousel vibration data. The wireless communication device 110 may use this information to set active acceleration and ranging intervals for certain parameters (e.g., BT Scan Rate 10% (30/300 ms), 75% (225/300 ms), etc.

The increase in aggressiveness of Bluetooth advertising and/or scanning may, for example, alleviate the issues associated with signal attenuation caused by the carousel or any other object that may attenuate the signals between the wirelessly locatable tag 120 and the wireless communication device 110.

The Bluetooth channel hopping may, for example, alleviate the issues associated with interference from other wireless protocols. For example, by channel hopping away from Bluetooth Channel 39 that may be interfered with by the Wi-Fi 2.4 GHz channel, there may be an increased chance that the Bluetooth connection between the wirelessly locatable tag 120 and the wireless communication device 110 may be established.

In the example embodiments, it was described that the Bluetooth parameters may be altered (e.g., operation 450 of the method 400) for the purposes of establishing a connection between the wireless communication device 110 and the wirelessly locatable tag 120. However, the BT parameters may also be altered after the connection is established based on the indication that the wirelessly locatable tag 120 is on the carousel. As described above, the carousel may cause attenuation of the BT signals when the connection is active. Thus, the wireless communication device 110 and/or the wirelessly locatable tag 120 may increase the transmit power or perform channel hopping during when the communication link is active to mitigate the issues caused by the carousel. Furthermore, while the parameters are described as BT parameters, the same altering of parameters may be performed for other communication protocols, e.g., UWB.

In 460, when the Bluetooth connection has been established between the wirelessly locatable tag 120 and the wireless communication device 110, the wirelessly locatable tag 120 may inform the wireless communication device 110 that the wirelessly locatable tag 120 is in a particular environment (e.g., on a carousel). For example, a special frame identification may be used to provide this information to the wireless communication device 110. Other manners of informing the wireless communication device 110 that the wirelessly locatable tag 120 is on a carousel may also be used.

In 470, the wireless communication device 110 may use this information for a variety of operations related to finding the wirelessly locatable tag 120. In a first example, since the wireless communication device 110 is now aware that the wirelessly locatable tag 120 is on a carousel, the wireless communication device 110 may start a UWB ranging operation with the wirelessly locatable tag 120. The UWB operation may consume a relatively large amount of power compared to the Bluetooth operation for both the wirelessly locatable tag 120 and the wireless communication device 110. Thus, the wireless communication device 110 may not want to start the UWB ranging operation until it is sure that the wirelessly locatable tag 120 is in a retrievable location, e.g., on the carousel. The UWB ranging may provide a more accurate location estimate than Bluetooth ranging.

In a second example, the wireless communication device 110 may provide a user with a notification, e.g., visual notification via GUI, audio notification, etc., that the wirelessly locatable tag 120 has arrived at the luggage carousel. In this example, the user is provided with the notification when the luggage is on the carousel and the wireless communication device 110 and the wirelessly locatable tag 120 have re-established the Bluetooth connection. Thus, the user experience may be improved because there is currently no manner for a baggage arrival notification to reach the user when the flight has landed and the devices are back in reconnected mode.

In a third example, the wireless communication device 110 may implement alterations to operations performed by the location engine 235 when it is aware the wirelessly locatable tag 120 is on the carousel. For example, an operation of the location engine 235 may be to display an arrow and/or ranging information on a GUI of the wireless communication device 110 to direct the user to the location of the wirelessly locatable tag 120. However, it has been observed that when the wirelessly locatable tag 120 is on a carousel, the display of the arrow/ranging information may be affected by the relatively small movement over time associated with the moving carousel, e.g., the arrow may display jitter or random movements. The location engine 235 may account for this carousel movement (e.g., based on feedback from the wirelessly locatable tag 120 such as carousel speed, acceleration, carousel vibration data, etc.) when displaying the arrow to provide a better user experience.

In a fourth example, the wireless communication device 110 may include a map, e.g., a map associated with the destination airport. The indication that the wirelessly locatable tag 120 is on a carousel may trigger a GUI to display the map to guide the user to the carousel on which the wirelessly locatable tag 120 is located.

The above examples are not mutually exclusive, e.g., multiple of the above examples may be implemented by the wireless communication device 110. In addition, the above are only examples and the wireless communication device 110 may implement other features based receiving the indication that the wirelessly locatable tag 120 is on the carousel.

In some example embodiments, the wireless communication device 110 may implement GUI features such as a notch. A notch may be, for example, a cut-out in the display of the wireless communication device 110. Some or all of the displays described above (e.g., display that luggage is checked in, display that luggage is on carousel, etc.) may be displayed in a notch of the wireless communication device 110.

### EXAMPLES

In a first example, a method comprising determining an apparatus is in a predetermined environment, determining there is no active communication connection to a wireless communication device and altering a parameter associated with establishing the active communication connection.

In a second example, the method of the first example, wherein the parameter comprises an advertisement rate that is increased.

In a third example, the method of the first example, wherein the parameter comprises a transmit power for advertisements that is increased.

In a fourth example, the method of the first example, further comprising determining there is an active communication connection to the wireless communication device and generating, for transmission to the wireless communication device, an indication that the apparatus is in the predetermined environment.

In a fifth example, the method of the fourth example, wherein the indication is transmitted via a special frame identification of the active communication connection.

In a sixth example, the method of the fourth example, further comprising determining one or more parameters associated with the predetermined environment and generating, for transmission to the wireless communication device, a message comprising the one or more parameters.

In a seventh example, the method of the sixth example, wherein the predetermined environment comprises a luggage carousel and wherein the one or more parameters comprise one of luggage carousel speed, luggage carousel acceleration or luggage carousel vibration.

In an eighth example, the method of the first example, wherein the apparatus further comprises an inertial measurement unit (IMU) sensor, wherein determining the apparatus is in the predetermined environment is based on data collected by the IMU sensor.

In a ninth example, the method of the eighth example, wherein the data collected by the IMU sensor comprises acceleration data.

In a tenth example, the method of the first example, wherein the active communication connection comprises a Bluetooth connection.

In an eleventh example, a processor configured to perform any of the methods of the first through tenth examples.

In a twelfth example, a wirelessly locatable tag configured to perform any of the methods of the first through tenth examples.

In a thirteenth example, a method, comprising determining context information for the apparatus, in response to the context information, determining there is no active communication connection to a wirelessly locatable tag and altering a parameter associated with establishing the active communication connection.

In a fourteenth example, the method of the thirteenth example, wherein the parameter comprises a scan rate that is increased.

In a fifteenth example, the method of the thirteenth example, wherein the parameter comprises a transmit power that is increased.

In a sixteenth example, the method of the thirteenth example, wherein the parameter comprises a channel on which scanning occurs.

In a seventeenth example, the method of the thirteenth example, further comprising determining there is an active communication connection and processing, based on signaling from the wirelessly locatable tag, an indication that the wirelessly locatable tag is in a predetermined environment.

In an eighteenth example, the method of the seventeenth example, wherein the indication is received via a special frame identification of the active communication connection.

In a nineteenth example, the method of the seventeenth example, further comprising, in response to processing the indication, performing an operation related to locating the wirelessly locatable tag.

In a twentieth example, the method of the nineteenth example, wherein the operation comprises initiating an ultra-wideband (UWB) ranging operation with the wirelessly locatable tag.

In a twenty first example, the method of the nineteenth example, wherein the operation comprises generating an alert indicating the wirelessly locatable tag is in the predetermined environment.

In a twenty second example, the method of the nineteenth example, wherein the operation comprises generating a display providing a user with a directional indication for locating the wirelessly locatable tag.

In a twenty third example, the method of the nineteenth example, further comprising processing, based on signaling from the wirelessly locatable tag, a message comprising one or more parameters associated with the predetermined environment, wherein generating the display is further based on the one or more parameters.

In a twenty fourth example, the method of the twenty third example, wherein the predetermined environment comprises a luggage carousel and wherein the one or more parameters comprise one of luggage carousel speed, luggage carousel acceleration or luggage carousel vibration.

In a twenty fifth example, the method of the nineteenth example, wherein the operation comprises generating a map display providing a user with a directions for locating the wirelessly locatable tag.

In a twenty sixth example, the method of the thirteenth example, wherein the active communication connection comprises a Bluetooth connection.

In a twenty seventh example, a processor configured to perform any of the methods of the thirteenth through twenty sixth examples.

In a twelfth example, a wireless communication device configured to perform any of the methods of the thirteenth through twenty sixth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
determine the apparatus is in a predetermined environment;
determine there is no active communication connection to a wireless communication device; and
alter a parameter associated with establishing an active communication connection.

2. The apparatus of claim 1, wherein the parameter comprises an advertisement rate that is increased.

3. The apparatus of claim 1, wherein the parameter comprises a transmit power for advertisements that is increased.

4. The apparatus of claim 1, wherein the processing circuitry is further configured to:
determine the active communication connection to the wireless communication device has been established; and
generate, for transmission to the wireless communication device, an indication that the apparatus is in the predetermined environment.

5. The apparatus of claim 4, wherein the indication is transmitted via a special frame identification of the active communication connection.

6. The apparatus of claim 4, wherein the processing circuitry is further configured to:
determine one or more parameters associated with the predetermined environment; and
generate, for transmission to the wireless communication device, a message comprising the one or more parameters.

7. The apparatus of claim 6, wherein the predetermined environment comprises a luggage carousel and wherein the one or more parameters comprise one of luggage carousel speed, luggage carousel acceleration or luggage carousel vibration.

8. The apparatus of claim 1, wherein the apparatus further comprises an inertial measurement unit (IMU) sensor, wherein determining the apparatus is in the predetermined environment is based on data collected by the IMU sensor.

9. An apparatus comprising processing circuitry configured to:
determine context information for the apparatus;
in response to the context information, determine there is no active communication connection to a wirelessly locatable tag; and
alter a parameter associated with establishing an active communication connection.

10. The apparatus of claim 9, wherein the parameter comprises a scan rate that is increased.

11. The apparatus of claim 9, wherein the parameter comprises a transmit power that is increased.

12. The apparatus of claim 9, wherein the parameter comprises a channel on which scanning occurs.

13. The apparatus of claim 9, wherein the processing circuitry is further configured to:
determine the active communication connection has been established; and
process, based on signaling from the wirelessly locatable tag, an indication that the wirelessly locatable tag is in a predetermined environment.

14. The apparatus of claim 13, wherein the indication is received via a special frame identification of the active communication connection.

15. The apparatus of claim 14, wherein the processing circuitry is further configured to:
in response to processing the indication, perform an operation related to locating the wirelessly locatable tag.

16. The apparatus of claim 15, wherein the operation comprises initiating an ultra-wideband (UWB) ranging operation with the wirelessly locatable tag.

17. The apparatus of claim 15, wherein the operation comprises generating an alert indicating the wirelessly locatable tag is in the predetermined environment.

18. The apparatus of claim 15, wherein the operation comprises generating a display providing a user with a directional indication for locating the wirelessly locatable tag.

19. The apparatus of claim 15, wherein the processing circuitry is further configured to:
process, based on signaling from the wirelessly locatable tag, a message comprising one or more parameters associated with the predetermined environment,
wherein generating the display is further based on the one or more parameters.

20. The apparatus of claim 19, wherein the predetermined environment comprises a luggage carousel and wherein the one or more parameters comprise one of luggage carousel speed, luggage carousel acceleration or luggage carousel vibration.
